(19) United States
(12) Patent Application Publication
(10) Pub. No.: US 2003/0129373 A1
(43) Pub. Date: Jul. 10, 2003

(54) Heat-sealable multilayer white opaque film

(76) Inventors: Robert A. Migliorini, North Haven, CT (US); Jay K. Keung, Victor, NY (US); Karen B. Perez, Pittsford, NY (US); Scott P. Wilkins, Pittsford, NY (US)

Correspondence Address: ExxonMobil Chemical Company, P.O. Box 2149, Baytown, TX, 77522-2149, US

(21) Appl. No.: 10/335,827

(22) Filed: Dec. 31, 2002

Related U.S. Application Data
(63) Continuation-in-part of application No. 09/666,928, filed on Sep. 21, 2000.
(60) Provisional application No. 60/159,205, filed on Oct. 13, 1999.

(51) Int. Cl. B32B 27/08; B32B 7/02

(52) U.S. Cl. 428/216; 428/517; 426/392

(57) ABSTRACT

A multilayer white opaque plastic film, heat-sealable on one or two sides, suitable for packaging uses. The multilayer film includes a cavitated core layer of polypropylene, a top intermediate tie-layer of polypropylene with interspersed titanium dioxide, a bottom intermediate tie-layer of polypropylene, a top and a bottom skin layer. The top skin layer is formed from a polylefin terpolymer or polypropylene. The top skin layer may include silicon dioxide and an antiblock agent, and optionally may be corona treated. The bottom skin layer is formed from a polylefin terpolymer, and may also include silicon dioxide and one or more antiblock or slip agents.

The present application claims the benefit of U.S. provisional application Serial No. 06/159,205 filed Oct. 13, 1999 and U.S. utility application Ser. No. 09/666,928 filed Sep. 21, 2000.

### BACKGROUND OF THE INVENTION

The present invention relates to multilayer plastic films and, more particularly, to heat-sealable multilayer white opaque films suitable for packaging of heat-sensitive items.

Plastic films are currently used in many food packaging operations. To be commercially viable, these plastic films must be economically priced, be compatible with modern high speed packaging machinery and methods, and be suitable for the particular packaging application.

It will be appreciated by those skilled in the art that certain packaging applications, e.g., packaging of heat-sensitive items such as frozen novelties, including ice cream bars and ice cream sandwiches, introduce certain specific design criteria into the packaging operation. These specific design criteria include sealability at low temperature and with minimum applied pressure, a distinctive pleasing appearance with at least one printable surface, and compatibility with high speed packaging, machinery and methods. To date, the prior art has been unable to provide a film exhibiting the aforementioned design criteria suitable for packaging heat-sensitive items such as frozen novelties, including ice cream bars and ice cream sandwiches.

There is therefore a need in the art for a heat-sealable multilayer white opaque film which is sealable at low temperature and with a minimum of applied pressure, provides a distinctive pleasing appearance with at least one printable surface, and is compatible with high speed packaging machinery and methods.

### SUMMARY OF THE INVENTION

The present invention, which addresses the needs of the prior art, relates to a heat-sealable multilayer white opaque plastic film which includes a cavitated polypropylene core layer having a first and a second surface. A top tie-layer formed of polypropylene and incorporating a whitening agent is positioned adjacent to the first surface of the core layer. A top skin layer of polypropylene, or a polyolefin terpolymer, containing an antiblock agent, overlays the top tie-layer. The film also has a polypropylene bottom tie-layer positioned adjacent to the second surface of the core layer. A bottom skin layer of a polyolefin terpolymer and one or more antiblock agents or antiblock slip agents is positioned adjacent to the bottom tie-layer.

In a first embodiment, the present invention provides a plastic film that is heat-sealable on one side. The top (non-sealable) skin layer of the film is formed from polypropylene. The cavitating agent incorporated into the polypropylene core layer is a polybutylene terephthalate polymer. The top and bottom tie-layers are formed from polypropylene and the polyolefin polymer of the bottom skin layer is a heat-sealable ethylene-propylene-butylene terpolymer. Silicone oil is used as an antiblock agent and the antiblock slip agent is a crosslinked silicone.

In a second embodiment, the present invention provides a plastic film that is heat-sealable on both sides. The top skin layer is an ethylene-propylene-butylene terpolymer containing SiO2 and an antiblock agent. The core layer contains a polybutylene terephthalate cavitating agent, a phosphite antioxidant, and a fluoropolymer as the anti-condensing agent. The polyolefin polymer of the bottom skin layer is an ethylene-propylene-butylene terpolymer, with silicone oil as the antiblock agent, and a crosslinked silicone as the antiblock slip agent.

The present invention also relates to a method of packaging a frozen novelty. The method includes the step of providing a frozen ice cream preparation. The method further includes the additional step of enclosing the ice cream preparation in a heat-sealable white opaque multilayer plastic film. Finally, the method includes the step of sealing the film to enclose the frozen ice cream preparation.

Thus, the present invention provides a packaging film which is scalable at a low temperature, and which is suitable for use with heat-sensitive items such as frozen novelties, including ice cream bars and ice cream sandwiches. Furthermore, the new films are compatible with modern high speed packaging machinery and methods, and are receptive to printing and labeling for marketing appeal.

These enhanced properties are achieved because the film of the present invention provides certain desirable characteristics including reduced plate-out (wear of machine surfaces due to scouring and abrasion by exposed film components, especially hard additives such as titanium dioxide, TiO2), and a consistent low coefficient of friction (COF), good hot-slip properties and improved hot-tack and z-tear resistance for packaging. As a result, the film seals with a minimum of applied heat or pressure and still has a pleasing appearance, with at least one printable surface.

### DETAILED DESCRIPTION OF THE INVENTION

The present invention provides a multilayer white opaque plastic film heat-sealable on one or two sides, with improved hot-tack and z-tear resistance characteristics; reduced plate-out; a lower and consistent coefficient of friction (COF); good hot-slip properties; and with a sealant layer that has a printable layer with a distinctive pleasing appearance. At least one exposed surface of the film is suitable for receiving an image which may be printed or affixed.

The plastic film of the present invention includes at least five layers. The core layer is the central layer of the five-layer film structure. On each surface of the core layer is a tie-layer. An outer skin layer is present on each side of the multilayer structure.

Each layer itself is formed from one or more polyolefin polymer compositions. Suitable polyolefin polymers include for example, polypropylene (PP), ethylene-propylene copolymers (EP), and ethylene-propylene-butylene terpolymers (EPB). It will be appreciated that skin layers formed from EP copolymers or EPB terpolymers typically exhibit heat-sealing properties. Thus, a multilayer film having one skin layer formed from heat-sealable polymers is heat-sealable on one side, whereas a multilayer film having both skin layers of a heat-sealable polymer is heat-sealable on two sides.

The multilayer polyolefin films of the present invention are opaque, white films. The opacity and whiteness characteristics are due to the presence of whitening agents, particles and cavitation in one or more layers of the film.

Preferably, the core layer of the multilayer film is rendered opaque as a result of cavitation within the layer. This cavitation is accomplished by adding an amount of a cavitating agent to the core layer prior to stretching of the film. When the multilayer film is subsequently stretched, the cavitating agent produces voids in the core layer which engender a characteristic opacity to the film. The cavitating agent may be any substance which has melting characteristics (including, for instance, melting point, and glass transition temperature) that are incompatible with the polyolefin of the layer to which it is added. Suitable cavitating agents include any polymer which is incompatible with the matrix polymer, such as, for example polybutylene terephthalate (PBT) in a polypropylene (PP) matrix. In a preferred embodiment, the core layer is formed from PP homopolymer of high stereo-regularity, i.e. film grade isotactic PP of high crystallinity.

The whitening agent or agents, which are incorporated into at least one layer of the film, also contribute to the whiteness and opacity of the films of the present invention. At least one of the tie-layers of the film comprises a whitening agent. Alternatively, the whitening agent may be present in two tie-layers. Suitable whitening agents include but are not limited to white pigments, such as for example TiO2, CaCO3, BaSO4, ZnS, MgCO3, clay, talc, kaolin, or any other highly reflective white compound. In a preferred embodiment, the whitening agent is TiO2. In an even more preferred embodiment, the whitening agent is the TiO2 product, RCL4® (Millenium Chemical Company, Red Bank, N.J.).

Other additives and agents may be suitable for incorporation into one or more layers of the films of the present invention. Additives may be selected from any class of additives, including for example, antioxidants, anti-condensing agents, slip agents, pigments, fillers, foaming agents, flame retardants, photodegradable agents, UV sensitizers or UV blocking agents, crosslinking agents, silicon compounds (e.g. SiO2) and antiblock agents to name but a few of the many known additives.

Antioxidants suitable for incorporation in the films of the present invention may be from any class of anti-oxidant, such as a phosphite, for example Ultranox® 626 (Borg-Warner Chemicals Inc., Parkersburg, Va.). The anti-condensing agent may be any anti-condensing agent, for example a fluoropolymer, such as for instance Dyneon® fluoropolymer FX9613 (3M, St. Paul, Minn.). The antiblock agents suitable for use with the films of the present invention may be any antiblock agent, for example a methyl acrylate, such as Epostar® MA 1002 (Nippon Shokubai, Osaka, Japan).

The silicon compounds include various forms of SiO2, which may be for example, in the form of coated or uncoated silica including for example, Sylobloc® 44 and Sylobloc® 45, respectively, supplied by W. R. Grace, New York, N.Y.; alternatively, the silicon compound may be, for example a silicone oil. The silicone oil may be any silicone oil, for example, SH200® (Dow Corning, Midland, Mich.). Many crosslinked silicone compounds are commercially available and are useful for incorporation into the films of the present invention. These include, for example, the preferred crosslinked siloxane compound Tospearl® manufactured by Toshiba Silicone, Tokyo, Japan.

The exposed surface of the top skin layer of the film of the present invention may be treated to provide the film with further useful properties and functionalities. These include for example corona treatment, metalizing and other such treatments well known in the art that enhance receptivity for printing, and especially for good compatibility with water-based inks.

Optimum film characteristics for machining include a low coefficient of friction, COF (good slip properties) and low block, i.e. the film surfaces should not stick together and should not interfere with rolling and packing. These characteristics are imparted by the slip agents and the antiblock agents, respectively, of the films of the present invention.

In particular, the present invention provides a heat-sealable multilayer white opaque plastic film in which the core layer is cavitated and is formed from polypropylene. The film has a top tie-layer of polypropylene and a whitening agent. This top tie-layer is positioned adjacent to the first surface of the core layer. A top skin layer of polypropylene or a polyolefin terpolymer is positioned adjacent to the top tie-layer. The top skin layer also contains SiO2 and an antiblock agent. A bottom tie-layer formed from polypropylene is positioned adjacent to the second surface of the core layer. A bottom skin layer formed from a polyolefin terpolymer is positioned adjacent to the bottom tie-layer and contains SiO2 and silicone oil as slip agent. The bottom skin layer may further contain one or more other antiblock agents or slip agents.

The core layer preferably includes a cavitating agent, an antioxidant and an anti-condensing agent. The cavitating agent preferably constitutes from about 7% to about 9% and may be any hard small particulate compound, preferably PBT. More preferably the cavitating agent is present at 8% by weight of the core layer and optimally is present in an amount sufficient to achieve a core layer density of about 0.55 g/cm3. The antioxidant, preferably a phosphite, preferably constitutes from about 500 ppm to about 700 ppm of the core layer by weight. Optimally the antioxidant is present at 600 ppm. Preferably the anti-condensing agent is a fluoropolymer and is present from about 200 ppm to about 400 ppm of the core layer by weight. Optimally the fluoropolymer is present at 300 ppm by weight.

The top tie-layer preferably include up to 10% by weight TiO2, preferably up to 8%, more preferably up to 6%, and optimally about 4% by weight TiO2. All percentages by weight are expressed as percent by weight of the layer into which they are incorporated, unless otherwise specified.

The bottom tie-layer formed from polypropylene can be free of additives, though films with a top tie-layer containing additives are not excluded from the invention.

The top skin layer preferably includes from about 0.1% by weight to about 0.5% SiO2, preferably from about 0.15% to about 0.4% SiO2, more preferably from about 0.2% to about 0.3% SiO2, and optimally about 0.23% by weight SiO2, such as silica. The silica may be any silica, for instance a Sylobloc® (W. R. Grace, New York, N.Y.) compound. The topskin layer further includes from about 0.1% to 0.5%, preferably from about 0.2% to about 0.4%, more preferably from about 0.15% to about 0.3%, and optimally about 0.2% by weight of a second antiblock agent, such as, a methyl acrylate, for instance Epostar® MA 1002 (Nippon Shokubai, Osaka, Japan).

The bottom skin layer is preferably formed from an EPB terpolymer. The bottom skin layer further includes from about 0.05% to about 0.15%, and optimally 0.1% by weight of an antiblock agent which may be any antiblock agent, for example a coated or uncoated silica. Preferably, the antiblock agent is Sylobloc® 44. The bottom skin layer yet further includes from about 0.15% to about 0.3% by weight of a second antiblock agent, which may be any antiblock agent, for example a crosslinked silicone, such as Tospearl® 130. This layer also includes from about 0.6% to 2.4%, preferably from about 0.9% to 1.8% (optimally 1.25%) by weight of a slip agent, such as a silicone oil.

In a yet further embodiment of the first aspect of the invention the total film polymer thickness of the heat-sealable multilayer white opaque plastic film is about 1 mil. The top skin layer constitutes between about 0.5% and about 5% of the total film polymer thickness. Preferably, the top skin layer constitutes about 1.5% or about 2.5% of the total film polymer thickness. The top tie-layer forms between about 5% and about 20% of the total film polymer thickness. Preferably, the top tie-layer forms about 15% of the total film polymer thickness. The bottom tie-layer forms between about 5% and about 20% of the total film polymer thickness. Preferably, the bottom tie-layer forms about 15% of the total film polymer thickness. The bottom skin layer constitutes between about 0.5% and about 10% of the total film polymer thickness. Preferably, the bottom skin layer constitutes about 4% or about 5% of the total film polymer thickness and the core layer accounts for the remainder of the total film polymer thickness.

In a particularly favored embodiment, the five-layer white opaque plastic film of the present invention is heat-sealable on one side and has the following composition: the top skin layer is corona treated and is formed from polypropylene and 0.23% by weight Sylobloc® 45 (W. R. Grace, New York, N.Y.) and 0.2% by weight Epostar® MA 1002 (Nippon Shokubai, Osaka, Japan); the top tie-layer is formed from polypropylene and 4% by weight Millenium RCL4® (Millenium Chemical Company, Red Bank, N.J.); the core layer is formed from polypropylene and includes 8% by weight PBT, 600 ppm Ultranox® 626 (Borg-Warner Chemicals Inc., Parkersburg, Va.), and 300 ppm of the fluoroplastic, Dyneon ® fluoropolymer FX9613 (3M, St. Paul, Minn.); the bottom tie-layer is also formed from polypropylene, and the bottom skin layer is formed from the EPB terpolymer, Chisso® 7753 and includes 1.2% by weight SH200® PDMS, 0.1% by weight Sylobloc® 44 (W. R. Grace, New York, N.Y.) and 0.23% by weight Tospearl® 130 (Toshiba Silicone, Tokyo, Japan).

In another particularly favored embodiment, the five-layer white opaque plastic film of the present invention is heat-sealable on two sides and has the following composition: the top skin layer is corona-treated and is formed from an EPB terpolymer, Chisso® 7300 or Chisso® 7320 and includes 0.23% by weight SiO2 as Sylobloc® 45, 0.2% by weight antiblock agent as Epostar® MA1002 (Cross-linked polymethacrylate, with a 2-3 μm average particle size; a refractive index of 1.49, and a specific gravity of 1.2 g/cm3), the top tie-layer includes 4% by weight TiO2 as Millenium RCL4®; the core layer includes polypropylene and 8% by weight of a cavitating agent, which is PBT; 600 ppm of an antioxidant phosphite which is Ultranox® 626 and 300 ppm of an anti-condensing agent which is the Dyneon® fluoropolymer FX9613; the bottom skin layer is formed from the EPB terpolymer, Chisso® 7753 (Chisso Corp., Osaka, Japan); and includes the antiblock agents, silicone oil, SH 200® PDMS at 1.2% by weight, uncoated silica, Sylobloc® 44 (W. R. Grace, New York, N.Y.) at 0.1% by weight and 0.23% by weight of the crosslinked silicone, Tospearl® 130 (Toshiba Silicone, Tokyo, Japan).

### EXAMPLES

### Example I (Comparative Example)

A three-layer, one side heat-sealable plastic film of the following composition was manufactured and provided for comparative purposes, with thicknesses shown in polymer gauge:

This surface optionally corona treated

| | | |
|---|---|---|
| Layer 1 | Exxon ® 4612 PP + | 25 ga |
| | 4% Millenium RCL4 ® TiO₂ | |
| Core | PP homopolymer of high stereo-regularity, e.g. Exxon ® | 65 ga |
| | 4612 + 8% PBT cavitating agent: Ticona Celanese ® | |
| | 1300A or equivalent | |
| Layer 2 | EPB terpolymer + 0.23% Sylobloc ® 44 + | 8 ga |
| | 1.25% silicone fluid: 30,000 centistokes | |

The layers were coextruded, quenched, reheated, and stretched to 5.3X in the machine direction. Subsequently, the sheet was reheated and stretched about 8-10X in a tenter frame. Skin 1 was corona treated to about 40 dynes/cm and wound in a mill roll form.

### Example 2

The following one side heat-sealable, five-layer film structure was produced according to the process of Example 1, with thicknesses shown in polymer gauge.

This surface optionally corona treated

| | | |
|---|---|---|
| Layer A | PP + 0.23% Sylobloc ® 45 + | 2-3 ga |
| | 0.2% Epostar ® MA 1002 | |
| Layer B | PP (Exxon ® 4612) + | 15 ga |
| | TiO₂ (4% Millenium RCL4 ®) | |
| Layer C | PP homopolymer of high stereo-regularity, such as | 61 ga |
| | Exxon ® 4612 + 8% PBT cavitating agent (Ticona | |
| | Celanese ® 1300A or equivalent) | |
| Layer D | PP | 15 ga |
| | (isotactic homopolymer) | |
| Layer E | EPB terpolymer (with DSC melting point of | 4 ga |
| | 122.5° C.) + 0.10% Sylobloc ® 44 + | |
| | 0.1% Tospearl ® T130 + 1.25% silicone fluid | |
| | (30,000 centistokes) | |

### Example 3

The following two side heat-sealable, five-layer film structure was produced according to the process of Example 1, with thicknesses shown in polymer gauge.

This surface optionally corona treated

| | | |
|---|---|---|
| Layer A | EPB terpolymer (with DSC melting point of | 2-3 ga |
| | 137° C.) + 0.23% Sylobloc ® 45 + 0.2% | |
| | Epostar ® MA 1002 | |
| Layer B | PP (Exxon ® 4612) + | 15 ga |
| | TiO₂ (4% Millenium RCL4 ®) | |
| Layer C | PP homopolymer of high stereo-regularity, such as | 61 ga |
| | Exxon ® 4612. 8% PBT cavitating agent (Ticona | |
| | Celanese ® 1300A or equivalent) | |
| Layer D | PP | 15 ga |
| | (isotactic homopolymer) | |
| Layer E | EPB terpolymer + 0.10% Sylobloc ® 44 + | 4 ga |
| | 0.1% Tospearl ® T130 + 1.25% silicone fluid | |
| | (30,000 centistokes) | |

The films of Examples 2 and 3 may further incorporate an antioxidant and/or a fluoropolymer into the top tie-layer. The films of Examples 2 and 3 have the following advantages over the film of comparative Example 1:

(a) The TiO₂ of the top tie-layer is retained within the film structure by the top skin layer of the film of Example 2, whereas the TiO₂ is exposed on the surface of the film of comparative Example 1. This retention of the TiO₂ in the film of Example 2 leads to the elimination of a number of processing problems including frictional abrasion by the TiO₂; fouling of the processing equipment by TiO₂ particles released from the film during processing, requiring frequent process interruption for cleaning; and product contamination by the released TiO₂ particles.

(b) The layer containing TiO₂ may be reduced from 25 ga in Layer 1 of Example 1 to 15 ga in Layer B of Examples 2 and 3, representing a 40% reduction in materials cost for this layer.

(c) The sealable layer may be reduced from 8 ga in Layer 3 of Example 1 to 4 ga of Layer E of Examples 2 and 3, representing a 50% lower material cost.

The film of Example 3 is heat-sealable on two sides, with a somewhat peelable seal, and is suitable for ice cream sandwich applications.

To simulate film performance in manufacturing, the following tests were run:

1. COF (Coefficient of friction) a dimensionless number obtained as follows:

$$COF = \frac{Force to cause sliding of film surfaces ( {g}_{f} )}{sled weight ( {g}_{f} )}$$

determined on the TMI Slip and Friction Tester Model No. 32-06 measuring film-to-film COF under conditions defined by ASTM D 1894. The sled is 2.5 in.×2.5 in and its weight is set at 200 g. In addition to the ASTM requirements, the measurements are taken using the moving sled pull method and a pull speed set at 6 in/min. The COF is the average kinetic COF (for moving friction) displayed by the TMI Tester after ½ in. of travel.

2. Hot-slip (Film on metal at high temperatures; TMI tester under conditions defined by ASTM D 1894).

3. TiO₂ plate-out testing ink adhesion monitoring on a Chestnut press (Flexo printing machine).

4. Fuji HFFS (Horizontal form, fill and seal): Testing for machinability with unsupported film (i.e. not laminated to any supporting film or structure), at 150 ft/min, with horizontal crimp jaws.

5. Hayssen VFFS (Vertical form, fill and seal): Laminating a standard 50 ga slip film (50 LBW) to the test film sample(s) and testing hot-tack in a 14 in package with 16 oz kidney beans as the test load.

Table 1 lists the performance and properties of these films. T/T: Treated surface against treated surface. U/U: Untreated surface against untreated surface. The films of Examples 2 and 3 provide a significantly lower and more consistent COF than the film of Example 1. The films of Example 1 and Example 2 provide good hot-slip properties and eliminate plate-out of the TiO2. The films of Example 2 provide good ink adhesion properties, while the films of Example 3 provide improved ink adhesion properties. The films of Example 2 and 3 provide good machinability. Finally, the films of Example 2 and 3 provide improved hot-tack, without creep and have improved z-tear performance (i.e. no puncturing or ripping in the direction perpendicular to the plane of the film), which is important for VFFS (Vertical form, fill and seal) applications.

TABLE 1
Film Properties and Performance

| | | | | | | | | Fuji HFFS* | | Hayssen VFFS** | |
|---|---|---|---|---|---|---|---|---|---|---|---|
| | | | Treated side | | | | | | Seal | | Seal |
| | COF | | hot-slip | | TiO₂ | Ink Adhesion | | | @ 290° F. | | @ 270° F. |
| Example | T/T | U/U | 250° F. | 275° F. | Plate-out | Solvent | Water | Machinability | (g/in) | Hot-tack*** | (g/in)** |
| 1 | 0.34 | 0.41 | 0.59 | 0.6 | Failed | Passed | OK | Passed | 405 | Creep 280-310° F. | 645 |
| 2 | 0.26 | 0.23 | 0.63 | 0.69 | Passed | Passed | OK | Passed | 695 | No Creep | 945 |
| 3 | 0.25 | 0.23 | 0.92 | 1.48 | Passed | Passed | Passed | Passed | 695 | No Creep | 945 |

| | |
|---|---|
| For TiO₂ | |
| Failed = Can wipe TiO₂ off film | Passed => 95% ink adhesion |
| surface | |
| Passed = Cannot wipe TiO₂ off film | OK = 50 to 95% ink |
| surface | adhesion |

*Fuji Alpha V Horizontal Form, Fill and Seal (HFFS) test conditions were as follows: Horizontal crimp jaw design, 70% eccentric pause, packaging speed = 150 feet per minute, 12.5 inch cut-off length of package, and 9 inch wide input web width.
**Hayssen Ultima II Vertical Form, Fill and Seal (VFFS) test conditions were as follows: Horizontal crimp jaw design, packaging speed = 72 packages per minute empty and 65 packages per minute filled, package layflat = 14 inches long by 5.25 inches wide, platen gap = 0.5 inch, standard Teflon ® taped back-up pad for the vertical seal bar.
***Hayssen Ultima II VFFS hot tack test conditions were as follows: product load = 16 ounces of red kidney beans, seal penetration measured in 32^{nd} of an inch. Unacceptable creep (designated “Creep” above) corresponds to 3/32 inch or greater seal penetration. Acceptable creep corresponds to less than or equal to 2/32” seal penetration. “No creep” corresponds to 0/32” seal penetration.

### Example 4

The one-side heat-sealable, five-layer film structure of this Example is produced according to the process of Example 1. The film structure differed from the structure shown in Example 2 only in that the bottom skin layer was increased to 5 gauge from 4 gauge in thickness. The increase in thickness of the bottom skin terpolymer layer provides better crimp seal strength.

Crimp seal strength is measured as follows: Seals are made with a Wrap-Ade Crimp sealer Model J or K modified with new PID temperature controllers. The crimp sealer jaws have a vertically serrated crimp design. The jaws are heated to the desired set point temperature controlled to within ±2° F. (1° C.) and the seal made by exerting 20 psi (1.4 bars) pressure with a dwell time of 0.75 seconds. The strength of the test seal is measured with a tensile tester, or more preferably a Suter tester pulling the seal apart at a rate of 12 in/min. while recording the peak force.

The film of Example 2 having a the bottom skin layer of 4 gauge thickness was compared in crimp seal tests with the film of Example 4 having a bottom skin layer of 5 gauge thickness, the average crimp seal strength (measured in g/in). The film structure of Example 4, having a 5 gauge bottom skin layer had an average crimp seal strength of 590 g/in with a standard deviation (s.d.) of ±126 g/in. By contrast, the film structure of Example 2, having a bottom skin layer of 4 gauge had a crimp seal strength of only 547 g/in with an s.d. of ±121 g/in.

The Cpk measurement of process robustness relates to a particular property of a product and the ability of the process to produce the product within the specification limits of the process. The higher the Cpk value, the more robust the process and the lower the rate of out of specification product produced.

The process robustness (Cpk) for the heat seal process with the film structure of Example 4 with a bottom skin layer of 5 gauge thickness was 1.03 compared with a Cpk value of 0.95 for the heat seal process using the film structure with a bottom skin layer of 4 gauge thickness. The defect rate (out of specification product) was reduced from about 2000 ppm (parts per million) to about 800 ppm.

The film structure of Example 4 therefore provides increased crimp seal strength and crimp seal process robustness as compared to the film structure of Example 2.

### Example 5

The two side heat-sealable, five-layer film structure of this Example was produced according to the process described in Example 1 and differed from the film structure of Example 3 in that the top skin layer was 1.5 gauge rather than 2.5 gauge, and the bottom skin layer was 5 gauge rather than 4 gauge in thickness. The increase in the thickness of the bottom skin terpolymer layer provides better crimp seal strength as noted above for the film of Example 4. Further, the top skin polymer layer is reduced in thickness from 2.5 gauge to 1.5 gauge to provide better hot-slip properties.

Hot-slip is a key attribute of the films of the present invention as it mimics the movement of a product packaged by the film over heated metal parts on a packaging machine. The hot-slip property of a film is expressed as a dimensionless number obtained by measuring the resistance to sliding over a heated metal surface. A lower hot-slip value relates to better hot-slip properties, indicating better performance characteristics of the film in labeling and packaging machinery.

To measure hot-slip a piece of aluminum foil is placed on a heated surface, in this case measured at 275° F. The film surface to be tested was placed over the aluminum foil. The film is weighted with a ±½ lb weight. The hot-slip measurement instrument then slides the foil against the film and measures the resistance.

In tests with films having the above-described composition of Example 5, varying only the thickness of the top skin layer, the following results were noted: With a bottom skin layer of 2.0 gauge or 2.5 gauge, hot-slip was similar, averaging 1.2 to 1.4 measured as described above. However, when the bottom skin layer was reduced to 1.5 gauge, the hot-slip was found to be significantly improved and averaged slightly under 1.0 when measured as before.

### Example 6 (Comparative Example)

The three layer, one side heat-sealable plastic film of this Example differed from the structure and composition of Comparative Example 1 only in that the core layer is not cavitated and does not contain the polybutylene terephthalate (PBT) cavitating agent.

### Example 7 (Comparative Example)

The one side heat-sealable, five-layer film structure of this Example is produced according to the process of Example 1. The film structure differed from the structure shown in Example 4 only in that the core layer is not cavitated does not contain the polybutylene terephthalate (PBT) cavitating agent.

### Example 8 (Comparative Example)

The two side heat-sealable, five-layer film structure of this Example was produced according to the process described in Example 1 and differed from the film structure of Example 5 only in that the core layer is not cavitated does not contain the polybutylene terephthalate (PBT) cavitating agent.

The Minimum Seal Temperatures and Crimp Seal Strengths of the films of Examples 1, 4, 5, 6, 7 and 8, were determined for sealing an inside surface against another area of an inside surface by standard methods as described above. The results are listed in Table 2 below.

TABLE 2
Minimum Seal Temperatures (° F.); Crimp Seal Strength (Inside/inside) g.

| Film | MST ° F. | 160° F. | 170° F. | 180° F. | 190° F. | 200° F. | 225° F. | 250° F. | 275° F. |
|---|---|---|---|---|---|---|---|---|---|
| Example 1 White | 192.6 | | | 82.5 | 125.0 | 435.0 | 720.0 | 380.0 | 325.0 |
| Example 4 White | 167.0 | 107.5 | 260.0 | 472.5 | | | 1050.0 | 500.0 | 495.0 |
| Example 5 White | 166.0 | 105.0 | 277.5 | 517.5 | | | 1025.0 | 425.0 | 675.0 |
| Example 6 Clear | 196.0 | | | 30.0 | 57.5 | 297.5 | 600.0 | 435.0 | 575.0 |
| Example 7 Clear | 184.0 | | | 147.5 | 290.0 | | 535.0 | 420.0 | 420.0 |
| Example 8 Clear | 181.0 | | | 192.5 | 312.5 | | 560.0 | 485.0 | 450.0 |

The Minimum Seal Temperature for the present purposes is the temperature which provides a seal strength of at least 200 g/in. The Minimum Seal Temperatures (MSTs) of the white, opaque films of Example 4 (MST=167° F.) and Example 5 (MST=166° F.), are substantially lower than the MSTs of the prior art films, including the white, opaque film of Example 1 (MST=192F).

The data shown in Table 2 shows that the substantially lower MSTs of the white, opaque films of Example 4 (MST=167° F.) and Example 5 (MST=166° F.) films are due in large part to presence of the polybutylene terephthalate (PBT) cavitating agent in the core layer. Compare the MSTs of the uncavitated films of otherwise identical compositions—designated “Clear” films of Example 7 (MST=184° F.) and Example 8 (MST=181° F.), respectively, in Table 2.

The substantially lower MSTs of the white, opaque films of Example 4 (MST=167° F.) and Example 5 (MST=166° F.) make these films more suitable for packaging and labeling heat sensitive products than the previously available films of the prior art, such as the film of Example 1 (MST=192.6° F.).

These substantial differences in the Minimum Seal Temperatures (MSTs) of the white, opaque films of the invention as compared with both the white, opaque film of Example 1 and the clear film of Example 6 of the prior art is unexpected and surprising.

For instance, the difference in the MSTs of the white, opaque film of Example 1 and the film of comparative Example 6 having the same structure and composition, but for the omission of the PBT cavitating agent in the core layer, is (196.0° F.-192.6° F.) only 3.4° F. In contrast, the difference in the MSTs of the white, opaque film of Example 4 and the film of comparative Example 7 having the same structure and composition, but for the omission of the PBT cavitating agent in the core layer, is (184.0° F.-167.0° F.) i.e. 17.0° F. Similarly, the difference in the MSTs of the white, opaque film of Example 5 and the film of comparative Example 8 having the same structure and composition, but for the omission of the PBT cavitating agent in the core layer, is (181.0° F.-166.0° F.) i.e. 15.0° F.

The approximately fivefold enhancement of the lowering of the MSTs of the films of Example 5 and Example 6 as compared with the prior art film of comparative Example 1, is striking and unexpected. Advantageously, the lower MSTs of the films of Example 5 and Example 6 make these films more suitable for the packaging and labeling of heat-sensitive and perishable items, particularly by modern high speed packaging machinery.

What is claimed is:

1. A heat-sealable multilayer white opaque plastic film, comprising:
i) a cavitated core layer comprising polypropylene and a cavitating agent comprising from about 7% to about 9% by weight polybutylene terephthalate, and having a first and a second surface;
ii) a top tie-layer comprising polypropylene and a whitening agent comprising up to 10% by weight TiO₂, said top tie-layer positioned adjacent to said first surface of the core layer;
iii) a top skin layer comprising polypropylene and from about 0.15% to about 0.3% by weight SiO₂ in the form of coated silica and from about 0.15% to about 0.25% by weight methylacrylate antiblock agent, said top skin layer positioned adjacent to said top tie-layer;
iv) a bottom tie-layer comprising polypropylene, said bottom tie-layer positioned adjacent to said second surface of the core layer; and
v) a bottom skin layer comprising an ethylene-propylene-butylene terpolymer, from about 0.6% to about 2.4% by weight silicone oil antiblock, and from about 0.15% to about 0.3% by weight crosslinked silicone; said bottom skin positioned adjacent to said bottom tie-layer.

2. The heat-sealable multilayer white opaque plastic film according to claim 1, wherein the top skin layer comprises between about 0.5% and about 5% of the total film polymer thickness, the top tie-layer comprises between about 5% and about 20% of the total film polymer thickness, the bottom tie-layer comprises between about 5% and about 20% of the total film polymer thickness, the bottom skin layer comprises between about 0.5% and about 10% of the total film polymer thickness and the core layer is of a thickness to bring the total film polymer thickness to about 1 mil.

3. The heat-sealable multilayer white opaque plastic film according to claim 2, wherein the top skin layer comprises about 1.5% of the total film polymer thickness, the top tie-layer comprises about 15% of the total film polymer thickness, the bottom tie-layer comprises about 15% of the total film polymer thickness, the bottom skin layer comprises about 5% of the total film polymer thickness and the core layer is of a thickness to bring the total film polymer thickness to about 1 mil.

4. A heat-sealable multilayer white opaque plastic film, comprising:
i) a cavitated core layer comprising polypropylene and a cavitating agent comprising from about 7% to about 9% by weight polybutylene terephthalate, and having a first and a second surface;
ii) a top tie-layer comprising polypropylene and a whitening agent comprising up to 10% by weight TiO₂, said top tie-layer positioned adjacent to said first surface of the core layer;
iii) a top skin layer comprising an ethylene-propylene-butylene terpolymer and from about 0.15% to about 0.3% by weight SiO₂ in the form of coated silica and from about 0.15% by weight to about 0.25% methylacrylate antiblock agent, said top skin layer positioned adjacent to said top tie-layer;
iv) a bottom tie-layer comprising polypropylene, said bottom tie-layer positioned adjacent to said second surface of the core layer; and
v) a bottom skin layer comprising an ethylene-propylene-butylene terpolymer, from about 0.6% to about 2.4% by weight silicone oil antiblock, and from about 0.15% to about 0.3% by weight crosslinked silicone; said bottom skin positioned adjacent to said bottom tie-layer.

5. The heat-sealable multilayer white opaque plastic film according to claim 4, wherein the top skin layer comprises between about 0.5% and about 5% of the total film polymer thickness, the top tie-layer comprises between about 5% and about 20% of the total film polymer thickness, the bottom tie-layer comprises between about 5% and about 20% of the total film polymer thickness, the bottom skin layer comprises between about 0.5% and about 10% of the total film polymer thickness and the core layer is of a thickness to bring the total film polymer thickness to about 1 mil.

6. The heat-sealable multilayer white opaque plastic film according to claim 5, wherein the top skin layer comprises about 2.5% of the total film polymer thickness, the top tie-layer comprises about 15% of the total film polymer thickness, the bottom tie-layer comprises about 15% of the total film polymer thickness, the bottom skin layer comprises about 5% of the total film polymer thickness and the core layer is of a thickness to bring the total film polymer thickness to about 1 mil.

7. A method of packaging a frozen novelty, comprising:
i) providing a frozen ice cream preparation,
ii) enclosing the ice cream preparation in a heat-sealable white opaque multilayer plastic film, and
iii) sealing the film to enclose the frozen ice cream preparation.

8. The method of claim 7, wherein the heat-sealable white opaque multilayer plastic film comprises:
i) a cavitated core layer comprising polypropylene and having a first and a second surface;
ii) a top tie-layer comprising polypropylene and a whitening agent, said top tie-layer positioned adjacent to said first surface of the core layer;
iii) a top skin layer comprising polypropylene or a polyolefin terpolymer, an antiblock agent, said top skin layer positioned adjacent to said top tie-layer;
iv) a bottom tie-layer comprising polypropylene, said bottom tie-layer positioned adjacent to said second surface of the core layer; and
v) a bottom skin layer comprising a polyolefin terpolymer, and one or more antiblock agents or antiblock slip agents, said bottom skin positioned adjacent to said bottom tie-layer.

9. The method of claim 7, wherein:
i) the top skin layer comprises polypropylene and from about 0.1% to about 0.5% by weight SiO₂, and from about 0.1% to about 0.5% by weight of a second antiblock agent,
ii) the top tie-layer comprises up to 10% by weight TiO₂,
iii) the cavitating agent of the core layer comprises polybutylene terephthalate,
iv) the polyolefin terpolymer of the bottom skin layer comprises an ethylene-propylene-butylene terpolymer; and
v) the bottom skin layer further comprises SiO₂, a silicone oil, and a crosslinked silicone.

10. The method of claim 9, wherein:
i) the top polypropylene skin layer comprises from about 0.15% to about 0.3% by weight SiO₂ in the form of coated silica and from about 0.15% to about 0.25% by weight methyl acrylate antiblock agent,
ii) the core layer comprises from about 7% to about 9% by weight polybutylene terephthalate,
iii) the bottom skin layer comprises an ethylene-propylene-butylene terpolymer and further comprises from about 0.6% to about 2.4% by weight silicone oil antiblock, and from about 0.15% to about 0.3% by weight crosslinked silicone antiblock slip agent.

11. The method of claim 10, wherein
i) the top skin layer comprises between about 0.5% and about 5% of the total film polymer thickness,
ii) the top tie-layer comprises between about 5% and about 20% of the total film polymer thickness,
iii) the bottom tie-layer comprises between about 5% and about 20% of the total film polymer thickness,
iv) the bottom skin layer comprises between about 0.5% and about 10% of the total film polymer thickness, and
v) the core layer is of a thickness to bring the total film polymer thickness to about 1 mil.

12. The method of claim 11, wherein
i) the top skin layer comprises about 1.5% of the total film polymer thickness,
ii) the top tie-layer comprises about 15% of the total film polymer thickness,
iii) the bottom tie-layer comprises about 15% of the total film polymer thickness,
iv) the bottom skin layer comprises about 5% of the total film polymer thickness, and
v) the core layer is of a thickness to bring the total film polymer thickness to about 1 mil.

13. The method of claim 8, wherein:
i) the top skin layer comprises an ethylene-propylene-butylene terpolymer,
ii) the cavitating agent of the core layer comprises polybutylene terephthalate, the antioxidant comprises a phosphite, and the anti-condensing agent comprises a fluoropolymer,
iii) the polyolefin terpolymer of the bottom skin layer comprises an ethylene-propylene-butylene terpolymer, and
iv) the bottom skin layer further comprises an antiblock agent and an antiblock slip agent, wherein the antiblock agent comprises silicone oil, and the antiblock slip agent comprises a crosslinked silicone.

14. The method of claim 13, wherein:
i) the top skin layer comprises ethylene-propylene-butylene-terpolymer and further comprises from about 0.15% to about 0.3% by weight SiO₂ in the form of coated silica, and from about 0.15% to about 0.25% by weight methyl acrylate antiblock agent,
ii) the core layer comprises from about 7% to about 9% by weight polybutylene terephthalate, and
iii) the bottom skin layer comprises ethylene-propylene-butylene terpolymer and further comprises from about 0.6% to about 2.4% by weight silicone oil antiblock, and from about 0.15% to about 0.3% by weight crosslinked silicone antiblock slip agent.

15. The method of claim 14, wherein
i) the top skin layer comprises between about 0.5% and about 5% of the total film polymer thickness,
ii) the top tie-layer comprises between about 5% and about 20% of the total film polymer thickness,
iii) the bottom tie-layer comprises between about 5% and about 20% of the total film polymer thickness, and
iv) the bottom skin layer comprises between about 0.5% and about 10% of the total film polymer thickness, and
v) the core layer is of a thickness to bring the total film polymer thickness to about 1 mil.

16. The method of claim 15, wherein
i) the top skin layer comprises about 2.5% of the total film polymer thickness,
ii) the top tie-layer comprises about 15% of the total film polymer thickness,
iii) the bottom tie-layer comprises about 15% of the total film polymer thickness, and
iv) the bottom skin layer comprises about 5% of the total film polymer thickness, and
v) the core layer is of a thickness to bring the total film polymer thickness to about 1 mil.
